(19) United States
(12) Patent Application Publication
(10) Pub. No.: US 2026/0359860 A1
(43) Pub. Date: Nov. 12, 2026

(54) Al-Driven Dynamic Recommender System for Customer Targeting and Budget Optimization in Multi-Channel Marketing

(71) Applicants: Sudha Amratlal Shah, Atlanta, GA (US); Jennifer Chandra Vaughn, Austin, TX (US)

(72) Inventors: Sudha Amratlal Shah, Atlanta, GA (US); Jennifer Chandra Vaughn, Austin, TX (US)

(21) Appl. No.: 19/553,394

(22) Filed: Mar. 1, 2026

Related U.S. Application Data
(60) Provisional application No. 63/769,129, filed on Mar. 9, 2025.

(51) Int. Cl. G06Q 30/0241; G06Q 30/0201; G06Q 30/0204; G06Q 30/0242

(52) U.S. Cl. CPC G06Q 30/0249; G06Q 30/02011; G06Q 30/0205; G06Q 30/0244

(57) ABSTRACT

Systems and methods are disclosed for dynamically controlling allocation of marketing budget across multiple marketing channels using causal measurement and closed-loop feedback. The system ingests customer, product, and channel interaction data and assigns customers, customer segments, treatment units, or geographic regions to treatment and control conditions with respect to marketing actions. Incremental impact attributable to marketing exposure is estimated using one or more causal inference techniques. Incremental impact estimates are aggregated to determine channel-level budget allocations, wherein budget allocations are outputs of the system rather than predefined constraints. The system automatically applies or causes application of budget reallocations across channels and iteratively updates subsequent treatment assignments and budget decisions based on observed outcomes. The disclosed system operates as an experimentation-driven control layer distinct from offline media mix modeling tools and impression-level advertising execution platforms.

### CROSS-REFERENCE TO RELATED APPLICATIONS

This application claims the benefit of U.S. Provisional Patent Application No. 63/769,129, filed Mar. 9, 2025, which is incorporated herein by reference in its entirety.

### TECHNICAL FIELD

The present disclosure relates to computer-implemented systems and methods for marketing decisioning. More particularly, the disclosure relates to systems and methods for causal, closed-loop control of marketing budget allocation across multiple marketing channels using experimentation-driven learning and automated execution.

### BACKGROUND

Organizations allocate marketing budgets across multiple channels, including digital advertising platforms, broadcast and streaming media, email, mobile applications, direct mail, and other owned or paid channels. Historically, budget allocation decisions have been informed by aggregate analytical techniques such as media mix modeling, heuristic planning tools, and retrospective performance reporting.

Such approaches typically infer channel effectiveness from historical correlations between aggregated spend and observed outcomes over fixed time intervals. While useful for high-level planning, these approaches operate offline, lack direct causal attribution at the customer or segment level, and require manual interpretation and execution by human decision-makers. As a result, they are poorly suited for environments in which customer behavior, channel performance, and marginal returns change dynamically.

Separately, advertising execution platforms, including demand-side platforms and ad servers, optimize impression-level decisions such as bid pricing or advertisement selection subject to externally defined budget constraints. These platforms do not determine how marketing budgets should be allocated across channels and do not measure incremental impact using controlled experimentation.

Accordingly, there exists a need for a system that automatically allocates and reallocates marketing budgets across channels based on causal measurements of incremental impact, and that operates as a closed-loop control system rather than as an offline planning tool or impression-level execution engine.

### SUMMARY OF THE INVENTION

The present disclosure provides systems and methods for dynamically controlling the allocation of marketing budget across multiple channels using causal measurements of incremental impact. The disclosed system operates as a closed-loop, experimentation-driven control system that automatically reallocates budgets based on measured incremental lift attributable to marketing exposure.

In one embodiment, the system assigns customers, customer segments, treatment units, or geographic regions to treatment and control groups with respect to one or more marketing actions, including channel exposure, product promotion, or messaging cadence. Incremental impact is estimated by comparing outcomes observed for treated entities relative to control entities using one or more causal inference techniques.

In certain embodiments, incremental impact is estimated at an individual customer or treatment-unit level with respect to specific marketing actions. Such estimates may be aggregated across customers, treatments, and channels to determine channel-level or campaign-level budget allocations. Budget allocations are outputs of the system rather than predefined constraints and are dynamically updated as additional experimental outcomes are observed.

The system automatically applies or causes application of budget reallocations across channels, thereby forming a continuous feedback loop in which experimentation, learning, and budget control are jointly optimized.

In certain embodiments, a recommender module generates marketing action recommendations comprising one or more of product selection, treatment selection, channel selection, timing, and associated budget allocation. The recommender module is retrained using outcomes observed from prior treatment and control assignments. In alternative embodiments, budget allocation instructions are transmitted to downstream execution systems while causal learning and budget determination remain centralized.

### BRIEF DESCRIPTION OF THE DRAWINGS

FIG. 1 illustrates a conceptual system architecture showing the disclosed system positioned between data platforms and marketing channel execution systems.

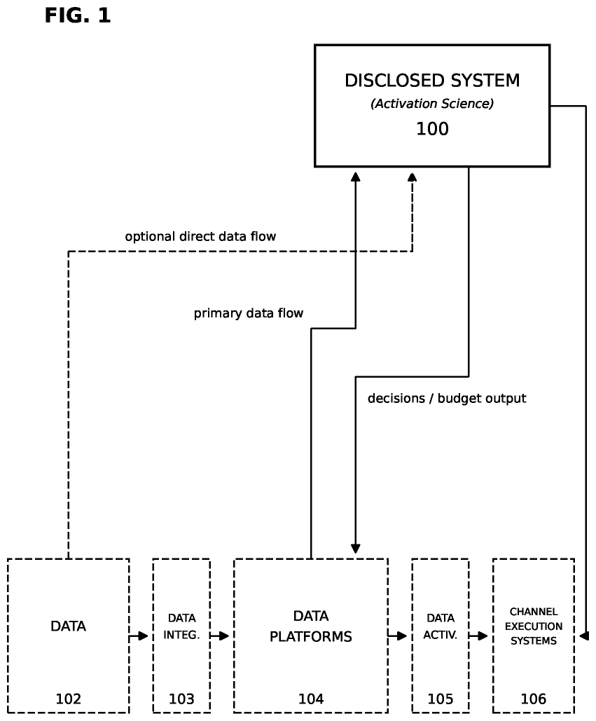

FIG. 2 illustrates an end-to-end system architecture showing data ingestion, causal modeling, segmentation, campaign execution, budget optimization, and feedback loops.

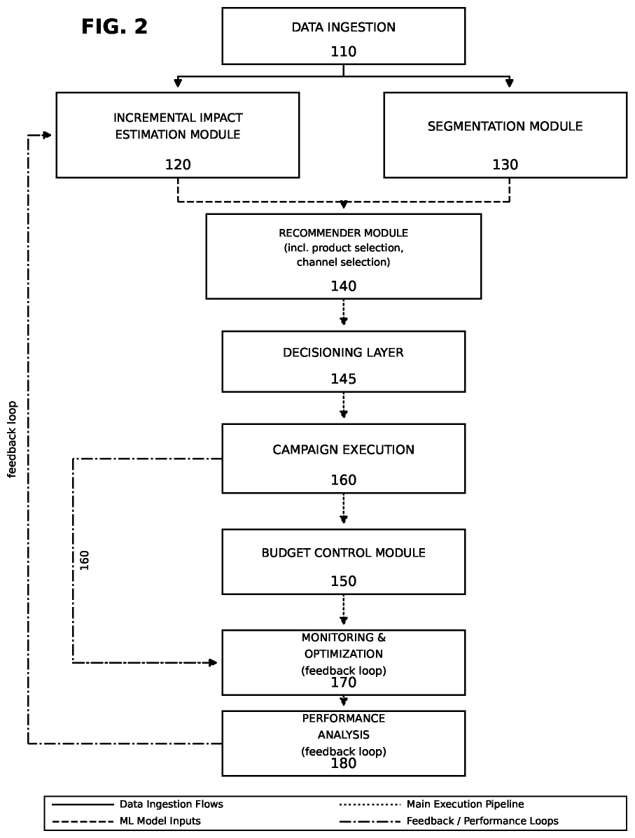

FIG. 3 illustrates an example customer journey demonstrating product-and channel-specific incremental impact and resulting budget reallocation.

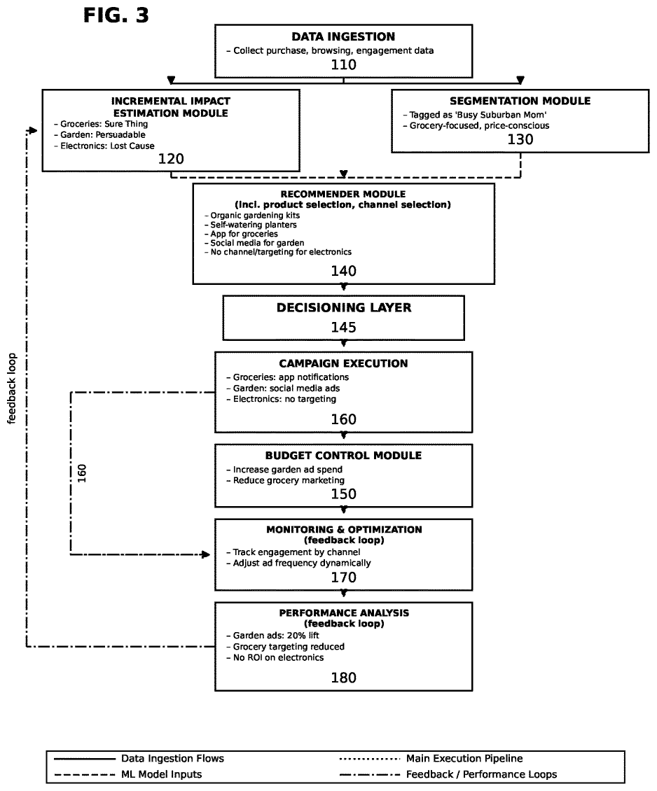

### DETAILED DESCRIPTION

### System Overview

Customer data, including demographic attributes, behavioral signals, transactional data, and engagement history, is ingested from one or more data sources. The disclosed system operates as an activation and control layer positioned between upstream data platforms and downstream channel execution systems.

Unlike data platforms that store or organize customer information, and unlike execution platforms that deliver marketing messages, the disclosed system determines how marketing budgets are allocated and reallocated using causal learning and closed-loop control.

In certain embodiments, causal learning is performed at an individual customer or treatment-unit level, and budget allocation decisions are derived by aggregating customer-level or treatment-level incremental impact estimates.

Marketing channels may include email, push messaging, SMS, social media, web-based advertising, direct mail, or other communication channels. Budget reallocation decisions generated by the system may be executed directly, partially executed, or transmitted as instructions to one or more downstream systems configured to execute marketing actions.

### Causal Modeling and Experimentation

Incremental impact attributable to marketing exposure is estimated using controlled experimentation. Customers, customer segments, geographic regions, or customer-treatment pairs are assigned to treatment and control conditions with respect to one or more marketing actions.

Incremental impact may be estimated using one or more causal inference techniques, including treatment-control comparisons, counterfactual prediction models, uplift models, difference-in-differences methods, synthetic control techniques, randomized experiments, or combinations thereof.

### Budget Optimization and Feedback

Incremental impact estimates are aggregated to determine channel-level, campaign-level, or portfolio-level budget allocations. In certain embodiments, incremental impact estimates are computed at an individual customer or treatment level and aggregated across customers, treatments, or other units of analysis to inform such budget allocations.

Adaptive allocation techniques may be applied to account for uncertainty, exploration-exploitation tradeoffs, or diminishing marginal returns. Observed outcomes following budget reallocation are fed back into the system to update causal models and subsequent allocation decisions.

In contrast to offline analytical approaches that estimate aggregate channel effects over historical time windows, the disclosed system applies experimentally measured incremental impact to inform forward-looking budget allocation decisions within an automated control loop.

### Geographic-level Embodiments

In some embodiments, experimentation and budget allocation are performed at a geographic level. Treatment and control conditions are assigned to geographic regions, and budget allocations are determined separately for each region.

### Long-Term Value Embodiments

In certain embodiments, incremental impact is evaluated with respect to long-term customer value, including customer lifetime value, retention probability, or cumulative revenue over a defined time horizon.

### Downstream Execution Embodiments

In certain embodiments, the system generates budget allocation instructions, derived from aggregated incremental impact estimates, for execution by one or more downstream marketing platforms, while retaining autonomous control over causal learning and budget determination.

### System Positioning

The disclosed system determines marketing budget allocation independently of impression-level bidding, ad auction mechanisms, or creative selection logic. The system further differs from offline analytical tools in that budget allocations are continuously updated based on experimentally measured incremental impact and automatically applied as part of an ongoing control loop.

1. A computer-implemented system for controlling marketing budget allocation across multiple marketing channels, comprising:
one or more processors; and
one or more non-transitory computer-readable storage media storing instructions that, when executed by the one or more processors, cause the one or more processors to:
(a) ingest customer, product, and channel interaction data;
(b) assign customers or customer segments to treatment and control groups with respect to one or more marketing actions;
(c) estimate incremental impact attributable to the one or more marketing actions by comparing outcomes observed for the treatment groups relative to the control groups;
(d) aggregate incremental impact estimates across customers or customer segments to determine channel-level budget allocations, wherein the channel-level budget allocations are outputs of the system;
(e) automatically reallocate marketing budgets across the multiple marketing channels in accordance with the channel-level budget allocations; and
(f) iteratively update subsequent treatment and control assignments and budget reallocations based on outcomes observed after reallocation,
wherein the system operates as a closed-loop control system distinct from offline media mix modeling tools and impression-level bidding platforms.

2. A computer-implemented system comprising:
an incremental impact estimation module configured to estimate incremental impact attributable to marketing exposure using one or more causal inference techniques, including at least one of treatment-control comparisons, counterfactual prediction models, uplift models, difference-in-differences methods, synthetic control methods, or randomized experiments;
a segmentation module configured to group customers based on one or more of behavioral attributes, transactional attributes, demographic attributes, or geographic attributes;
a recommender module configured to generate marketing action recommendations comprising product selection, channel selection, and budget allocation based on outputs of the incremental impact estimation module and the segmentation module; and
a budget control module configured to automatically reallocate marketing budgets across multiple marketing channels in accordance with the marketing action recommendations,
wherein the recommender module is retrained using outcomes observed for prior treatment and control assignments.

3. A computer-implemented method for reallocating marketing budget across multiple marketing channels, the method comprising:
(a) assigning customers or customer segments to treatment and control groups with respect to marketing exposure;
(b) measuring incremental impact attributable to the marketing exposure by comparing outcomes of the treatment groups to outcomes of the control groups;
(c) aggregating incremental impact measurements across customers or customer segments to determine channel-level budget allocations;
(d) automatically applying the channel-level budget allocations to reallocate marketing budget across the multiple marketing channels; and
(e) repeating steps (a) through (d) based on outcomes observed after reallocation.

4. The system of claim 1, wherein estimating incremental impact comprises applying a causal inference model selected from the group consisting of uplift models, counterfactual prediction models, randomized experiments, difference-in-differences models, and synthetic control models.

5. The system of claim 1, wherein the incremental impact is estimated at a customer-level, segment-level, product-category level, or geographic-region level.

6. The system of claim 1, wherein aggregating incremental impact estimates comprises applying an adaptive allocation algorithm to account for uncertainty and diminishing marginal returns.

7. The system of claim 6, wherein the adaptive allocation algorithm comprises a multi-armed bandit algorithm.

8. The system of claim 1, wherein budget reallocations are subject to governance constraints including minimum channel spend, maximum channel spend, pacing constraints, or risk thresholds.

9. The system of claim 1, wherein automatically reallocating marketing budgets comprises generating budget allocation instructions for execution by one or more downstream marketing platforms.

10. The method of claim 3, wherein automatically applying the channel-level budget allocations comprises transmitting budget allocation instructions to one or more external systems configured to execute marketing campaigns.

11. The system of claim 1, wherein customers are grouped by geographic region, and incremental impact is estimated at a geographic-region level.

12. The system of claim 11, wherein channel-level budget allocations are determined separately for each geographic region.

13. The method of claim 3, wherein assigning customers or customer segments to treatment and control groups comprises assigning geographic regions to treatment and control conditions.

14. The system of claim 1, wherein incremental impact is estimated with respect to predicted long-term customer value.

15. The system of claim 14, wherein the predicted long-term customer value comprises customer lifetime value.

16. The method of claim 3, wherein reallocating marketing budget is based on incremental impact measured over a time horizon extending beyond an initial conversion event.

17. The system of claim 1, wherein the system does not determine bid prices for individual ad impressions.

18. The system of claim 1, wherein the system operates independently of ad auctions and impression-level bidding logic.

19. The system of claim 2, wherein the recommender module jointly optimizes product selection, channel selection, and budget allocation.

20. The method of claim 3, wherein marketing exposure is withheld for at least one product-category-channel combination to establish a control condition.
